(19) United States
(12) Patent Application Publication
(10) Pub. No.: US 2014/0011390 A1
(43) Pub. Date: Jan. 9, 2014

(54) WIRING BODY CONNECTION STRUCTURE

(71) Applicant: TOKAI RUBBER INDUSTRIES, LTD., Aichi-ken (JP)

(72) Inventors: Koichi HASEGAWA, Aichi-ken (JP); Tomonori HAYAKAWA, Aichi-ken (JP); Hitoshi UKAI, Aichi-ken (JP)

(73) Assignee: TOKAI RUBBER INDUSTRIES, LTD., Aichi-ken (JP)

(21) Appl. No.: 14/019,874

(22) Filed: Sep. 6, 2013

Related U.S. Application Data
(63) Continuation of application No. PCT/JP2012/082741, filed on Dec. 18, 2012.

(30) Foreign Application Priority Data
Jan. 13, 2012 (JP) 2012-004988

(51) Int. Cl. H01R 9/15

(52) U.S. Cl. CPC H01R 9/15
USPC 439/371

(57) ABSTRACT

A wiring body connection structure includes: a first wiring body having a flexible substrate made of an elastomer, and a flexible wire containing an elastomer and a conductive material; and a second wiring body connected to the first wiring body. The first wiring body has a first connection portion on which the second wiring body is stacked in a front-back direction so as to be connected to the first connection portion, and a first body portion connecting to the first connection portion, and the width of the flexible substrate in the first connection portion is larger than that of the flexible substrate in the first body portion. The second wiring body has a second connection portion that is stacked on the first connection portion, and the second connection portion is formed by a wiring portion where a wire connected to the flexible wire of the first connection portion is disposed.

### TECHNICAL FIELD

The present invention relates to wiring body connection structures that electrically connect a flexible extendable/contractible wiring body using an elastomer to another wiring body capable of being connected to a connector of a circuit board.

### BACKGROUND ART

Flexible sensors, actuators, etc. are under development by using elastomers. For example, electrodes and wires are formed on the surfaces of a pair of substrates each made of an elastomer. The pair of substrates are arranged such that the electrodes face each other with a dielectric layer interposed therebetween, whereby an electrostatic capacitance sensor can be formed (see, e.g., Patent Document 1). If load is applied to the electrostatic capacitance sensor, the substrates are bent and the distance between the electrodes changes. The electrodes and the wires are made of a flexible conductive material formed by blending conductive carbon and metal powder with an elastomer, so that the electrodes and the wires can extend and contract according to the deformation of the substrates.

In such a flexible sensor etc., one ends of the wires are connected to the electrodes and the other ends thereof are connected to an electric circuit such as a control device. One method to connect a flexible wiring body to an electric circuit is to directly connect the end of the wiring body to an existing connector provided on a circuit board. According to the existing connector, an electrode of the connector is engaged with the wiring body to electrically connect the wiring body to the electric circuit. However, the wiring body extends and contracts according to deformation of a sensor section etc. connected. Repeated extension and contraction cause settling of the wiring body due to compression permanent deformation of the elastomer. In the connection using mechanical engagement between the wiring body and the connector, the connection portion cannot conform to the settling of the wiring body. This may cause defective contact between the wiring body and the connector. The substrate forming the wiring body is made of an elastomer. The wires are also formed by using an elastomer as a base material. Accordingly, the wiring body has relatively low mechanical strength. This may result in cracks in the wires etc. due to the engagement of the connector. Thus, if the flexible wiring body using an elastomer is connected to an existing connector, there is a problem with reliability of the connection portion. It is therefore difficult to directly connect the flexible wiring body to the existing connector.

As a solution to this problem, Patent Document 2 discloses a method of connecting a flexible wiring body to one end of an existing wiring body such as a flexible flat cable (FFC) or flexible printed circuits (FPC) and connecting the other end of the FFC etc. to a connector of a circuit board. According to this method, the flexible wiring body is indirectly connected to the connector of the circuit board via the FFC etc.

### RELATED ART DOCUMENTS

### Patent Documents

[Patent Document 1] Japanese Patent Application Publication No. 2010-43880 (JP 2010-43880 A)

[Patent Document 2] Japanese Patent Application Publication No. 2011-34822 (JP 2011-34822 A)

[Patent Document 3] Japanese Examined Utility-Model Application Publication No. H06-37538

### SUMMARY OF THE INVENTION

### Problem to be Solved by the Invention

In a flexible wiring body, wires extend and contract together with a substrate. On the other hand, an existing wiring body such as an FFC neither extends nor contracts. Rigidity of the FFC is very high as compared to that of the flexible wiring body. Accordingly, in the case where the end of the flexible wiring body and the end of the FFC are stacked and connected together, large stress is caused near the tip end of the FFC in the stacked portion if the flexible wiring body is extended when receiving load. The flexible wiring body is therefore strained to a larger extent in a region near the tip end of the FFC than in the remaining region. Accordingly, repeated extension and contraction of the flexible wiring body may cause disconnection of the wires located near the tip end of the FFC.

The present invention was developed in view of such a situation, and it is an object of the present invention to provide a wiring body connection structure capable of suppressing wire disconnection while in use and implementing connection between a flexible wiring body and an electric circuit with high reliability.

### Means for Solving the Problem

(1) In order to solve the above problem, a wiring body connection structure according to the present invention is characterized by including: a first wiring body having a flexible substrate made of an elastomer, and a flexible wire disposed on the flexible substrate and containing an elastomer and a conductive material; and a second wiring body connected to the first wiring body, wherein the first wiring body has a first connection portion on which the second wiring body is stacked in a front-back direction so as to be connected to the first connection portion, and a first body portion connecting to the first connection portion, and a width of the flexible substrate in the first connection portion is larger than that of the flexible substrate in the first body portion, and the second wiring body has a second connection portion that is stacked on the first connection portion, and the second connection portion is formed by a wiring portion where a wire connected to the flexible wire of the first connection portion is disposed, and two protruding portions protruding from both sides in a lateral direction of the wiring portion beyond the wiring portion in a direction of the first wiring body.

The first wiring body has the flexible substrate made of an elastomer, and the flexible wire containing an elastomer as a base material. The first wiring body is flexible and can extend and contract. For example, existing wiring bodies such as an FFC and an FPC can be used as the second wiring body. The existing wiring bodies such as an FFC can be connected to existing connectors such as a ZIF (zero Insertion Force) connector. According to the wiring body connection structure of the present invention, the flexible and extendable/contractible first wiring body can be indirectly connected to a connector of a circuit board via the second wiring body.

As described above, in the case where the end of the flexible wiring body and the end of the existing wiring body are stacked and connected together, stress is concentrated near the tip end of the existing wiring body in the stacked portion due to extension of the flexible wiring body. In this regard, according to the wiring body connection structure of the present invention, the first connection portion of the first wiring body and the second connection portion of the second wiring body are stacked in the front-rear direction to form a stacked portion. First, in the first wiring body, the width of the flexible substrate in the first connection portion is larger than that of the flexible substrate in the first body portion. That is, the width of the first connection portion is larger than that of the first body portion.

If the width of the first connection portion is increased, stress in the stacked portion is dispersed in the lateral direction accordingly. Stress that is caused near the tip end of the second wiring body is thus reduced, and strain of the first wiring body in this portion can be reduced. Stress that is caused near the tip end of the second wiring body is increased particularly in both ends in the lateral direction. Accordingly, the portion where stress is concentrated can be located away from a region where the flexible wire is disposed (hereinafter sometimes referred to as the “flexible wire region”) by increasing the width of the flexible substrate in the first connection portion to increase the width of the stacked portion. Since the second connection portion is stacked in the widened portion, this widened portion also serves as a reinforcing plate reinforcing the stacked portion. As used herein, the term “width” refers to the length in a direction substantially perpendicular to the in the front-back direction and the extension direction of the first wiring body.

Next, in the second wiring body, the second connection portion stacked on the first connection portion is formed by the wiring portion and the two protruding portions. The wire connected to the flexible wire of the first connection portion is disposed on the wiring portion. That is, the wiring portion of the second connection portion faces the flexible wire region of the first connection portion. The two protruding portions are placed on both sides in the axial direction of the wiring portion. Thus, the two protruding portions are placed so as to face both sides in the axial direction of the flexible wire region in the first connection portion, namely the regions where no flexible wire is disposed. Moreover, the two protruding portions protrude beyond the wiring portion in the direction of the first wiring portion. Thus, the tip ends of the two protruding portions are located on the first wiring body side with respect to the wiring portion. For example, provided that the point of effort is the point where load is applied upon extension of the first wiring body, and the fulcrum is the fixed stacked portion, the point of load is the end of the stacked portion which is located on the first wiring body side. Stress caused upon extension is concentrated on the point of load located closest to the point of effort. Accordingly, stress can be concentrated on the tip end parts of the two protruding portions by placing the tip ends of the two protruding portions on the first wiring body side with respect to the wiring portion. This reduces stress in the region other than the tip end portions of the two protruding portions, namely stress near the tip end of the wiring portion, and thus can reduce strain of the first wiring body (flexible wire region) near the tip end of the wiring portion.

Since the width of the flexible substrate of the first connection portion is increased and the two protruding portions protruding in the direction of the first wiring body are placed on both sides of the wiring portion in the second connection portion, stress can be distributed in the lateral direction, and stress can be concentrated on the portion where no flexible wire is disposed. This can suppress disconnection of the flexible wire disposed near the tip end of the second wiring body. The wiring body connection structure of the present invention thus has high durability. According to the wiring body connection structure of the present invention, connection between the flexible and extendable/contractible wiring body and an electric circuit can be implemented with high reliability.

(2) It is preferable that, in the configuration of (1), strain of the flexible wire near a boundary between the first connection portion and the first body portion be smaller than that of the flexible wire of the first body portion.

The region near the tip end of the second wiring body where stress tends to be caused upon extension corresponds to the region near the boundary between the first connection portion and the first body portion in the first wiring body. According to this configuration, strain of the flexible wire in the region where large stress tends to be caused is smaller than that of the flexible wire of the first body portion as a base. Thus, the present invention has a significant effect of suppressing disconnection of the flexible wire, which tends to occur in conventional examples, and can further improve durability of the wiring body connection structure.

(3) It is preferable that, in the configuration of (1) or (2), in the first connection portion, the width of the flexible substrate is at least 1.05 times that of a region where the flexible wire is disposed.

This configuration can reduce strain of the flexible wiring near the tip end of the second wiring body. The more the width of the flexible substrate is increased in the first connection portion, the more the stress that is caused upon extension can be dispersed in the lateral direction. The widened portion has a significant effect of reinforcing the stacked portion. Thus, the width of the flexible substrate in the first connection portion is made at least 1.15 times, and more preferably at least 1.2 times the width of the flexible wire region.

(4) It is preferable that, in the configuration of any one of (1) to (3), an end of the second connection portion in the direction of the first wiring body have a recessed shape formed by connecting the two protruding portions and the wiring portion by a curve, as viewed in the front-back direction.

In the case of using an existing wiring body such as an FFC and an FPC as the second wiring body, the end of the second wiring body need be cut to form the second connection portion. According to this configuration, the two protruding portions and the wiring portion are connected by a curve in the end in the front-back direction of the second connection portion. Thus, the end of the second wiring body can be easily cut, and the second connection portion can be easily formed.

(5) It is preferable that, in the configuration of any one of (1) to (4), the first wiring body have a plurality of the flexible wires, the second wiring body have a plurality of the wires, a conductive adhesive layer be placed between the first connection portion and the second connection portion, and the conductive adhesive layer be made of an anisotropic conductive adhesive that allows the flexible wire and the wire facing each other in the front-back direction to be electrically connected to each other.

The first wiring body and the second wiring body are bonded by the conductive adhesive layer. Accordingly, defective contact is less likely to occur as compared to mechanical connection using engagement. Since the conductive adhesive layer has both conductive and adhesive properties, the stacked portion can be reduced in size and thickness as compared to the case where the first connection portion and the second connection portion are connected by other members.

The conductive adhesive layer is made of an anisotropic conductive adhesive. The anisotropic conductive adhesive is an adhesive having conductive particles dispersed in adhesive insulating resin or adhesive insulating rubber (base material). Examples of the anisotropic conductive adhesive include a thermosetting anisotropic conductive adhesive, a thermoplastic anisotropic conductive adhesive, an ultraviolet curable anisotropic conductive adhesive, an elastomer-based anisotropic conductive adhesive, etc. depending on the type of base material. When a pressure is applied to the anisotropic conductive adhesive, the conductive particles in the base material point-contact each other in one direction between the connection members, forming a conduction path. The anisotropic conductive adhesive is solidified or cured in this state, whereby conductive properties are developed. As used herein, the term “solidify” refers to a reversible change in state which involves no chemical reaction, and the term “cure” refers to an irreversible change in state which involves a chemical reaction such as a cross-linking reaction.

The anisotropic conductive adhesive has properties in which it is highly conductive in one direction (anisotropic conductive properties). Accordingly, interposing the anisotropic conductive adhesive between the first connection portion and the second connection portion can bond the wires facing each other in the front-back direction, and can electrically connect the wires in the thickness direction of the anisotropic conductive adhesive (front-back direction). In this case, the anisotropic conductive adhesive is less conductive in the planar direction. Accordingly, regarding the flexible wires and the wires of the second wiring body, adjoining ones of the wires are not electrically connected to each other.

(6) It is preferable that, in the configuration of any one of (1) to (5), the first body portion have a cover film that insulates the flexible wire from outside.

According to this configuration, the flexible wire can be insulated from the outside, thereby improving safety. Waterproof properties of the flexible wire can be ensured or oxidization can be suppressed depending on the material of the cover film.

### Effects of the Invention

In the wiring body connection structure of the present invention, disconnection of the flexible wire is less likely to occur even if the first wiring body extends and contracts. The wiring body connection structure of the present invention thus has high durability. According to the wiring body connection structure of the present invention, the flexible and extendable/contractible first wiring body using an elastomer can be connected to a connector of a circuit board through the second wiring body with high reliability.

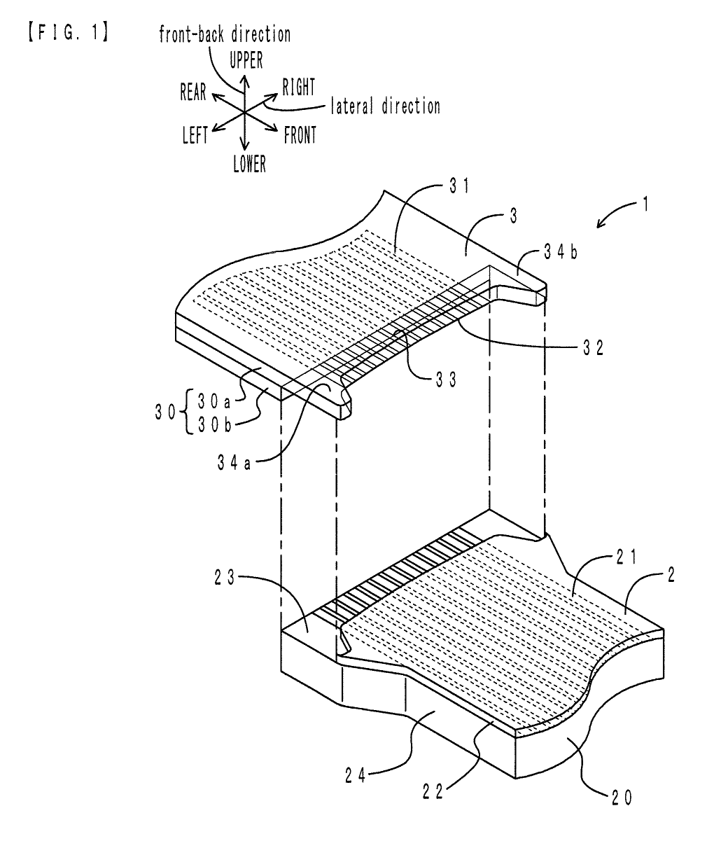

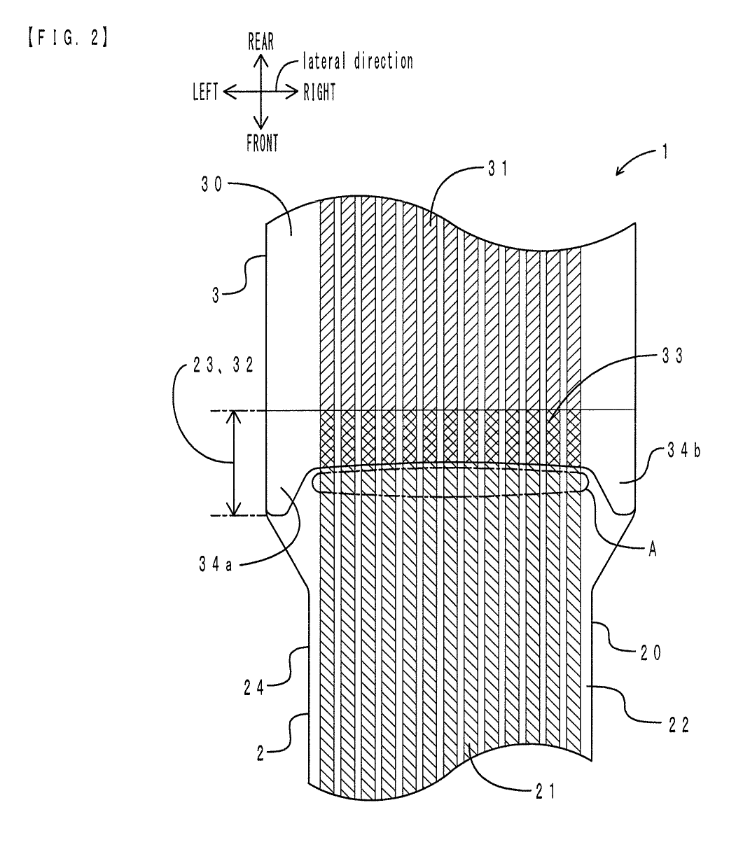

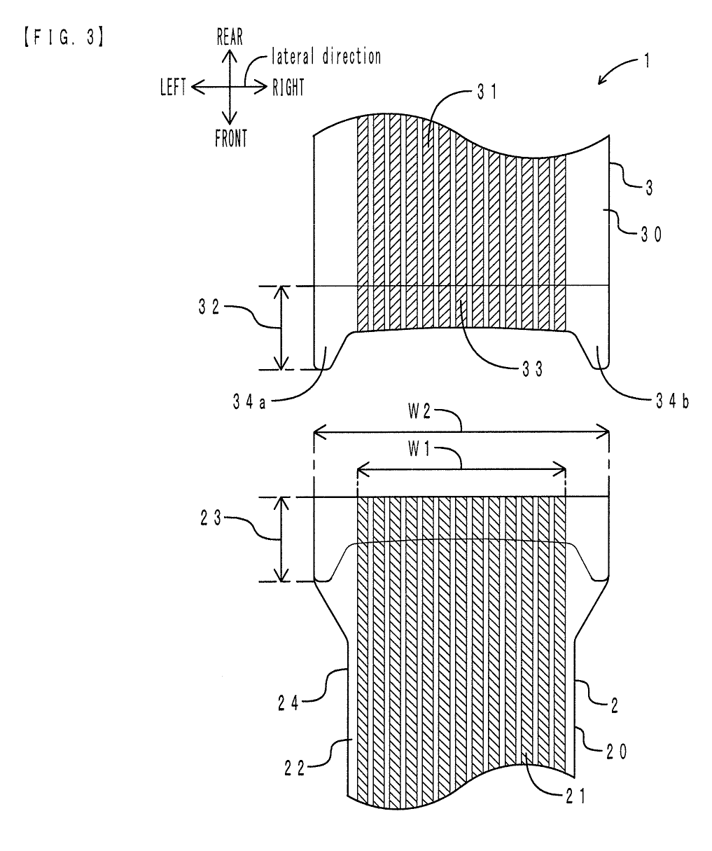

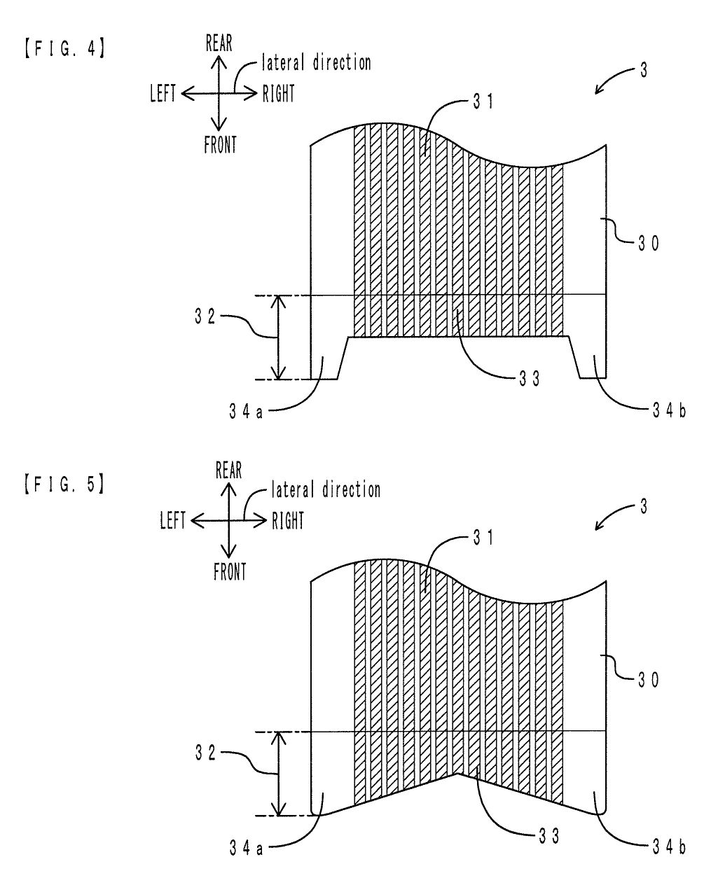

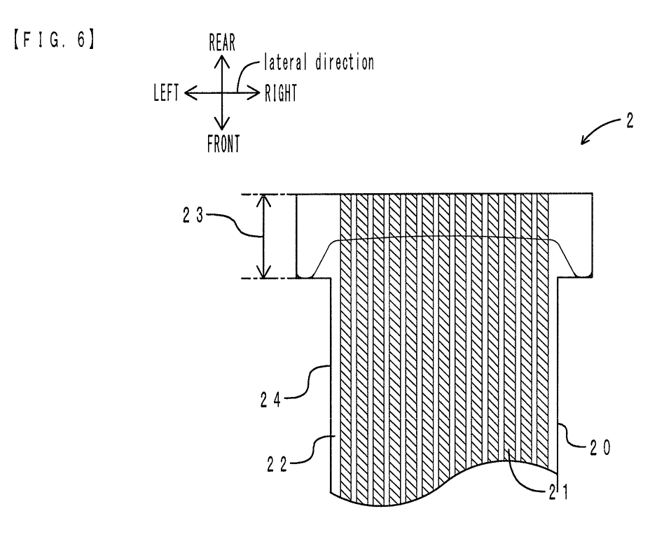

### BRIEF DESCRIPTION OF THE DRAWINGS

[FIG. 1] FIG. 1 is a perspective exploded view of a wiring body connection structure of a first embodiment of the present invention.

[FIG. 2] FIG. 2 is a transparent top view of the wiring body connection structure.

[FIG. 3] FIG. 3 is a transparent exploded top view of the wiring body connection structure.

[FIG. 4] FIG. 4 is a transparent top view of a second wiring body of a second embodiment.

[FIG. 5] FIG. 5 is a transparent top view of a second wiring body of a third embodiment.

[FIG. 6] FIG. 6 is a transparent top view of a first wiring body of a fourth embodiment.

### DESCRIPTION OF THE REFERENCE NUMERALS

1: Wiring Body Connection Structure

2: First Wiring Body

20: Flexible Substrate

21: Flexible Wire

22: Cover Film

23: First Connection Portion

24: First Body Portion

3: FFC (Second Wiring Body)

30: Insulating Substrate

30a, 30b: Film Member

31: Wire

32: Second Connection Portion

33: Wiring Portion

34a, 34b: Protruding Portion

W1: Flexible Wire Region Width

W2: Width of Flexible Substrate

### MODES FOR CARRYING OUT THE INVENTION

Embodiments of a wiring body connection structure of the present invention will be described below.

### First Embodiment

[Configuration]

First, the configuration of a wiring body connection structure of the present embodiment will be described. FIG. 1 is a perspective exploded view of the wiring body connection structure of the present embodiment. FIG. 2 is a transparent top view of the wiring body connection structure. FIG. 3 is a transparent exploded top view of the wiring body connection structure. In FIG. 1, flexible wires of a first wiring body and wires of an FFC (second wiring body) are shown transparently. In FIGS. 2 and 3, the flexible wires of the first wiring body and the wires of the FFC are shown transparently by hatched areas. As shown in FIGS. 1 to 3, a wiring body connection structure 1 includes a first wiring body 2 and an FFC 3.

The first wiring body 2 has a flexible substrate 20, flexible wires 21, and a cover film 22. The flexible substrate 20 is made of silicone rubber, and has a strip shape extending in the front-rear direction. The flexible substrate 20 has a thickness of about 0.5 mm.

A total of thirteen flexible wires 21 are disposed on the upper surface (front surface) of the flexible substrate 20. The flexible wires 21 contain acrylic rubber and silver powder. The flexible wires 21 are formed by screen-printing wire paint, which contains an acrylic rubber polymer and silver powder, on the upper surface of the flexible substrate 20. Each of the flexible wires 21 has a linear shape. The flexible wires 21 extend in the front-rear direction. The thirteen flexible wires 21 are arranged substantially parallel to each other at predetermined intervals in the left-right direction (lateral direction).

The cover film 22 is made of silicone rubber, and has a strip shape extending in the front-rear direction. The cover film 22 has a thickness of about 20 μm. The cover film 22 covers the upper surface of the flexible substrate 20 and the upper surfaces of the flexible wires 21 from the front to the front end of a first connection portion 23, described below.

The first wiring body 2 has the first connection portion 23 and a first body portion 24. The first connection portion 23 is placed in the rear end of the first wiring body 2. The first connection portion 23 is not covered by the cover film 22. That is, the flexible wires 21 are exposed on the upper side in the first connection portion 23. A second connection portion 32 of the FFC 3, described below, is stacked on the upper surface of the first connection portion 23 with a conductive adhesive layer (not shown) interposed therebetween. The first body portion 24 extends to the front of the first wiring body 2 continuously with the first connection portion 23.

The width (length in the left-right direction) of the first connection portion 23 is larger than that of the first body portion 24. That is, the width of the flexible substrate 20 in the first connection portion 23 is larger than that of the flexible substrate 20 in the first body portion 24. The width of the flexible substrate 20 is increased in an invertedly tapered manner from the rear of the first body portion 24 to the first connection portion 23. As shown in FIG. 3, in the first connection portion 23, the ratio of the width W2 of the flexible substrate 20 to the flexible wire region width WI is larger than that in the first body portion 24, where “W1” represents the width of the region where the flexible wires 21 are disposed (hereinafter referred to as the “flexible wire region width”). Specifically, the width W2 of the flexible substrate 20 in the first connection portion 23 is 1.2 times the flexible wire region width W1.

The FFC 3 has an insulating substrate 30 and wires 31. The insulating substrate 30 has a strip shape extending in the front-rear direction. The insulating substrate 30 is formed by two film members 30a, 30b. The two film members 30a, 30b are made of polyester, and are stacked in the up-down direction. Each of the two film members 30a, 30b has a thickness of about 0.1 mm.

The wires 31 are tin-plated copper foil. A total of thirteen wires 31 are interposed between the two film members 30a, 30b. The wires 31 have a thickness of about 0.1 mm. Each of the wires 31 has a linear shape. The wires 31 extend in the front-rear direction. The thirteen wires 31 are arranged substantially parallel to each other at predetermined intervals in the left-right direction (lateral direction). The FFC 3 is included in the second wiring body in the present invention.

The FFC 3 has the second connection portion 32. The second connection portion 32 is placed in the front end of the FFC 3. In the second connection portion 32, the film member 30b has been delaminated so as to expose the wires 31 on the lower surface (back) side of the film member 30a. That is, in the second connection portion 32, there is no film member 30b, and the wires 31 are exposed on the lower side. The first connection portion 23 of the first wiring body 2 is stacked on the lower surface of the second connection portion 32 with a conductive adhesive layer (not shown) interposed therebetween. The conductive adhesive layer is made of an anisotropic conducive adhesive having nickel particles dispersed in epoxy resin. The first connection portion 23 and the second connection portion 32 are thus bonded together. The width and intervals of the flexible wires 21 of the first connection portion 23 are the same as those of the wires 31 of the second connection portion 32. The flexible wires 21 are thus electrically connected to the wires 31 via the conductive adhesive layer. The rear end of the FFC 3 is connected to a connector (not shown). The connector is mounted on an electric circuit board (not shown).

The second connection portion 32 is formed by a wiring portion 33 and two protruding portions 34a, 34b. The thirteen wires 31 are disposed on the wiring portion 33. The thirteen wires 31 are electrically connected to the thirteen flexible wires 21 of the first connection portion 23, respectively. The protruding portion 34a is located on the left side of the wiring portion 33. The protruding portion 34a protrudes forward beyond the wiring portion 33. Similarly, the protruding portion 34b is located on the right side of the wiring portion 33. The protruding portion 34b protrudes forward beyond the wiring portion 33. The two protruding portions 34a, 34b and the wiring portion 33 are connected by a curve as viewed in the up-down direction (front-back direction). That is, the front end of the second connection portion 32 has a recessed shape formed by connecting the two protruding portions 34a, 34b and the wiring portion 33 by a curve. The width of the second connection portion 32 is the same as that of the first connection portion 23 (width W2 of the flexible substrate 20).

[Manufacturing Method]

A method for manufacturing the wiring body connection structure 1 will be described. The method for manufacturing the wiring body connection structure 1 includes a wiring body preparing step, a placing step, and a bonding step. in the wiring body preparing step, the first wiring body 2 and the FFC 3 are prepared. That is, regarding the first wiring body 2, wire paint is first screen-printed in a predetermined pattern on the upper surface of the flexible substrate 20, thereby forming the thirteen flexible wires 21. Next, cover film paint is printed so as to cover the upper surface of the flexible substrate 20 and the upper surfaces of the flexible wires 21 except the first connection portion 23, thereby forming the cover film 22 of the first body portion 24. Regarding the FFC 3, a commercially available FFC is cut to form the second connection portion 32.

In the placing step, the first wiring body 2, the anisotropic conductive adhesive, and the FFC 3 are stacked and placed. Specifically, the anisotropic conductive adhesive in a paste form before curing is first applied to the upper surface of the first connection portion 23 of the first wiring body 2. Next, the second connection portion 32 of the FFC 3 is placed on the anisotropic conductive adhesive. At this time, the first connection portion 23 and the second connection portion 32 are placed such that the flexible wires 21 of the first connection portion 23 face the wires 31 of the second connection portion 32, respectively.

In the bonding step, the anisotropic conductive adhesive is cured to bond the flexible wire 21 and the wire 31 facing each other in the up-down direction, so that the flexible wire 21 and the wire 31 can be electrically connected to each other. Specifically, a stacked portion where the first wiring body 2, the anisotropic conductive adhesive, and the FFC 3 are stacked is heated from the FFC 3 side and pressed in the up-down direction. This cures the anisotropic conductive adhesive, forming the conductive adhesive layer. As a result, the first connection portion 23 and the second connection portion 32 are bonded together.

[Functions and Effects]

Functions and effects of the wiring body connection structure 1 will be described. According to the wiring body connection structure 1, the front end of the FFC 3 is connected to the first wiring body 2, and the rear end of the FFC 3 is connected to the connector mounted on the electric circuit board. The flexible and extendable/contractible first wiring body 2 can thus be connected to the electric circuit board by using the existing FFC 3.

The width of the first connection portion 23 is larger than that of the first body portion 24. That is, the width of the flexible substrate 20 in the first connection portion 23 is larger than that of the flexible substrate 20 in the first body portion 24. Specifically, the width W2 of the flexible substrate 20 in the first connection portion 23 is 1.2 times the flexible wire region width W1. Accordingly, upon extension of the first wiring body 2, stress that is caused in the stacked portion where the first connection portion 23 and the second connection portion 32 are stacked is dispersed in the lateral direction (left-right direction). Thus, stress that is caused near the tip end of the FFC 3, namely near the boundary between the first connection portion 23 and the first body portion 24 (region A surrounded by chain line in FIG. 2), is decreased, and strain of the first wiring body 2 in the region A can be reduced. Moreover, increasing the width of the flexible substrate 20 allows the portion where the stress is concentrated to be located away in the lateral direction from the region where the flexible wires 21 are disposed. No flexible wire 21 is disposed in the widened portion of the flexible substrate 20. The two protruding portions 34a, 34b of the second connection portion 32 are stacked on this portion. This reinforces the stacked portion.

The two protruding portions 34a, 34b of the second connection portion 32 protrude forward beyond the wiring portion 33. The tip ends of the two protruding portions 34a, 34b are thus located on the first wiring body 2 side with respect to the wiring portion 33. This can concentrate stress on the tip end parts of the two protruding portions 34a, 34b. As a result, stress in the remaining region, namely near the tip end of the wiring portion 33 (region A surrounded by chain line in FIG. 2), is reduced. This can reduce strain of the first wiring body 2 in the region A.

Since the width of the flexible substrate 20 in the first connection portion 23 is increased and the two protruding portions 34a, 34b protruding in the direction of the first wiring body 2 (forward) are placed on both sides of the wiring portion 33 of the second connection portion 32, stress can be dispersed in the lateral direction, and stress can be concentrated on the portion where no flexible wire 21 is disposed. Thus, strain of the flexible wires 21 disposed near the tip end of the FFC 3 (region A) becomes smaller than that of the flexible wires 21 in the first body portion 24. This can suppress disconnection of the flexible wires 21 disposed near the tip end of the FFC 3 (region A). The wiring body connection structure 1 thus has high durability. According to the wiring body connection structure 1, connection between the first wiring body 2 and an electric circuit can be implemented with high reliability.

The front end of the FFC 3, i.e., the end of the second connection portion 32 in the direction of the first wiring body 2, has a recessed shape formed by connecting the two protruding portions 34a, 34b and the wiring portion 33 by a curve, as viewed in the up-down direction (see FIGS. 2 and 3). That is, the front end of the second connection portion 32 has an R-shape. The second connection portion 32 can thus be easily formed by cutting the front end of the FFC 3.

In the first body portion 24, the flexible wires 21 are covered by the cover film 22. The flexible wires 21 can thus be insulated from the outside, which ensures safety. Moreover, waterproof properties of the flexible wires 21 can be ensured, and oxidization can be suppressed.

The first connection portion 23 and the second connection portion 32 are bonded by the conductive adhesive layer. Defective contact is therefore less likely to occur as compared to mechanical connection using engagement. Since the conductive adhesive layer has both conductive and adhesive properties, the stacked portion can be reduced in size and thickness as compared to the case where the first connection portion 23 and the second connection portion 32 are connected by other members.

The conductive adhesive layer is made of the anisotropic conductive adhesive. The conductive adhesive layer has poor conductive properties in the left-right direction. Accordingly, in the first connection portion 23, the flexible wires 21 adjoining each other in the left-right direction are not electrically connected to each other. Similarly, in the second connection portion 32, the wires 31 adjoining each other in the left-right direction are not electrically connected to each other. Using the anisotropic conductive adhesive as the conductive adhesive layer allows the plurality of wires 21, 31 facing each other to be collectively bonded and electrically connected to each other.

### Other Embodiments

The embodiment of the wiring body connection structure of the present invention is described above. However, embodiments are not particularly limited to the above embodiment. The present invention can be embodied in various modified forms or improved forms that can be achieved by those skilled in the art.

For example, in the above embodiment, an FFC was used as the second wiring body. However, the second wiring body is not limited to the FFC. For example, flexible printed circuits (FPC) etc. may be used as the second wiring body. With the FPC, a desired wiring pattern can be easily formed by etching. It is therefore easy to change the interval between adjoining wires or to bond and consolidate the wires. The type of connector that connects the second wiring body is not particularly limited. For example, existing connectors (ZIF connector etc.) capable of connecting to the FPC, FFC, etc. can be used.

The end shape of the second connection portion of the second wiring body is not particularly limited. The end shape of the second connection portion of the second wiring body need only be a shape that is recessed toward the second wiring body side as viewed from the front-back direction. Other embodiments of the second connection portion will be described below. FIG. 4 is a transparent top view of a second wiring body of a second embodiment. FIG. 5 is a transparent top view of a second wiring body of a third embodiment. In FIGS. 4 and 5, members corresponding to those of FIG. 3 are denoted with the same reference characters.

As shown in FIG. 4, the second connection portion 32 is formed by the wiring portion 33 and the two protruding portions 34a, 34b. In the front end of the second connection portion 32, the two protruding portions 34a, 34b and the wiring portion 33 are connected by a straight line. The front end of the second connection portion 32 has an angular shape that is recessed in a trapezoidal shape toward the second wiring body side. As shown in FIG. 5, in the front end of the second connection portion 32, the two protruding portions 34a, 34b and the wiring portion 33 are connected by a single straight line. The front end of the second connection portion 32 has a V-shape recessed toward the second wiring body side.

The number of wires in the first wiring body and the second wiring body is not particularly limited. For example, a single flexible wire may be connected to a single wire in the second wiring body. In the case where the number of wires in the second wiring body is larger than that of flexible wires in the first wiring body, only those wires which face the flexible wires are used. In this case, those wires which are not connected to the flexible wires are disposed on both sides or one side of the wiring portion of the second connection portion. This reinforces the protruding portions. The effect of reinforcing the stacked portion is therefore improved.

In addition to the silicone rubber in the above embodiment, ethylene-propylene copolymer rubber, natural rubber, styrene-butadiene copolymer rubber, acrylonitrile-butadiene copolymer rubber, acrylic rubber, epichlorohydrin rubber, chlorosulfonated polyethylene, chlorinated polyethylene, urethane rubber, fluororubber, chloroprene rubber, isobutylene isoprene rubber, various thermoplastic elastomers, etc. can be used as the elastomer forming the flexible substrate of the first wiring body.

The flexible wires contain an elastomer and a conductive material. The elastomer may be the same as or different from the elastomer of the flexible substrate. Preferred examples include, in addition to the acrylic rubber in the above embodiment, silicone rubber, ethylene-propylene copolymer rubber, natural rubber, styrene-butadiene copolymer rubber, acrylonitrile-butadiene copolymer rubber, urethane rubber, epichlorohydrin rubber, chlorosulfonated polyethylene, chlorinated polyethylene, etc. The type of conductive material is not particularly limited. Preferred examples include metal powder such as silver, gold, copper, and nickel, conductive carbon powder, etc. In order to develop desired conductive properties, it is desirable that the filling rate of the conductive material in the elastomer be 20 vol % or more in the case where the volume of the flexible wires is 100 vol %. The filling rate of the conductive material exceeding 65 vol % impairs molding processability as it is difficult to mix the conductive material with the elastomer. This filling rate also impairs extensibility and contractility of the flexible wires. It is therefore desirable that the filling rate of the conductive material be 50 vol % or less.

The method of forming the flexible wires is not particularly limited. For example, unvulcanized thin-film wires are first produced from wire paint containing components that form the flexible wires. Next, these wires are disposed on the surface of the flexible substrate, and are pressed under predetermined conditions to be vulcanization-bonded. Alternatively, the wire paint may be printed on the surface of the flexible substrate, and then dried by heating to volatilize a solvent in the paint. According to the printing method, a cross-linking reaction of the elastomer component can proceed simultaneously with drying during heating. Examples of the printing method include, in addition to the screen printing of the above embodiment, ink jet printing, flexo printing, gravure printing, pad printing, lithography, etc. Especially, the screen printing method is preferable because high viscosity paint can be used and the paint film thickness can be easily adjusted. The wire paint can be prepared by mixing components that form flexible wires (an elastomer, a conductive material, an additive, etc.) with a solvent.

In the first wiring body, the width of the flexible substrate in the first connection portion need only be larger than that of the flexible substrate in the first body portion. The width of the flexible substrate in the first connection portion is at least 1.05 times, preferably at least 1.15 times, and more preferably at least 1.2 times the flexible wire region width.

The manner in which the width of the flexible substrate is increased is not particularly limited. For example, the width of the flexible substrate may be gradually increased from the rear of the first body portion to the first connection portion in the invertedly tapered manner of the above embodiment or in a stepped manner. As shown in a transparent top view of a first wiring body of a fourth embodiment in FIG. 6, the width of the flexible substrate 20 of the first connection portion 23 may be increased in a single step from the first body portion 24 (in FIG. 6, members corresponding to those of FIG. 3 are denoted with the same reference characters).

Preferred examples of the material of the cover film include, in addition to the silicone rubber in the above embodiment, ethylene-propylene copolymer rubber, natural rubber, styrene-butadiene copolymer rubber, acrylonitrile-butadiene copolymer rubber, acrylic rubber, epichlorohydrin rubber, chlorosulfonated polyethylene, chlorinated polyethylene, urethane rubber, fluororubber, chloroprene rubber, isobutylene isoprene rubber, various thermoplastic elastomers, etc.

In the above embodiment, an anisotropic conductive adhesive containing epoxy resin (thermosetting adhesive) as a base material is used as the conductive adhesive layer. As a base compound of the thermosetting adhesive, phenol resin, acrylic resin, polyurethane, etc. can be used in addition to the epoxy resin. An additive such as a curing agent may be combined as appropriate according to the type of main component. In the case where only one wire is provided in each of the first wiring body and the second wiring body, the conductive adhesive layer does not have to have anisotropy.

Regardless of whether the conductive adhesive layer has anisotropy or not, a thermoplastic adhesive, an ultraviolet curable adhesive, an elastomer-based adhesive, etc. can be used in addition to the thermosetting adhesive as a base material of the conducive adhesive forming the conductive adhesive layer.

In the case of using a thermosetting adhesive, a thermosetting adhesive that is cured at a low temperature in a short time is desirable in order to suppress thermal expansion of the elastomer of the first wiring body. Specifically, it is desirable that a thermosetting adhesive is cured at a temperature in the range of 130° C. to 180° C., both inclusive. Moreover, it is desirable that a thermosetting adhesive is cured in 60 seconds or less, and more desirably in 20 seconds or less. Preferred examples of the anisotropic conductive adhesive containing a thermosetting adhesive as a base material include anisotropic adhesive conductive connection materials “TAP0402F,” “TAP0401C” manufactured by KYOCERA Chemical Corporation, etc.

### INDUSTRIAL APPLICABILITY

The wiring body connection structure of the present invention is useful in connecting an extendable/contractible wiring body in flexible sensors, actuators, etc. using an elastomer to an electric circuit.

1. A wiring body connection structure, characterized by comprising:
a first wiring body having a flexible substrate made of an elastomer, and a flexible wire disposed on the flexible substrate and containing an elastomer and a conductive material; and
a second wiring body connected to the first wiring body, wherein
the first wiring body has a first connection portion on which the second wiring body is stacked in a front-back direction so as to be connected to the first connection portion, and a first body portion connecting to the first connection portion, and a width of the flexible substrate in the first connection portion is larger than that of the flexible substrate in the first body portion, and
the second wiring body has a second connection portion that is stacked on the first connection portion, and the second connection portion is formed by a wiring portion where a wire connected to the flexible wire of the first connection portion is disposed, and two protruding portions protruding from both sides in a lateral direction of the wiring portion beyond the wiring portion in a direction of the first wiring body.

2. The wiring body connection structure according to claim 1, wherein
upon extension of the first wiring body, strain of the flexible wire near a boundary between the first connection portion and the first body portion is smaller than that of the flexible wire of the first body portion.

3. The wiring body connection structure according to claim 1, wherein
in the first connection portion, the width of the flexible substrate is at least 1.05 times that of a region where the flexible wire is disposed.

4. The wiring body connection structure according to claim 1, wherein
an end of the second connection portion in the direction of the first wiring body has a recessed shape formed by connecting the two protruding portions and the wiring portion by a curve, as viewed in the front-back direction.

5. The wiring body connection structure according to claim 1, wherein
the first wiring body has a plurality of the flexible wires,
the second wiring body has a plurality of the wires,
a conductive adhesive layer is placed between the first connection portion and the second connection portion, and
the conductive adhesive layer is made of an anisotropic conductive adhesive that allows the flexible wire and the wire facing each other in the front-back direction to be electrically connected to each other.

6. The wiring body connection structure according to claim 1, wherein
the first body portion has a cover film that insulates the flexible wire from outside.
